(19) United States
(12) Patent Application Publication
(10) Pub. No.: US 2015/0280477 A1
(43) Pub. Date: Oct. 1, 2015

(54) FUEL CELL SYSTEM INCLUDING FUEL CELL AND LEAD-ACID BATTERY, AND CHARGING METHOD FOR THE SAME

(71) Applicant: PANASONIC CORPORATION, Osaka (JP)

(72) Inventors: Junya Kusumoto, Nara (JP); Masaki Mitsui, Kyoto (JP); Takashi Akiyama, Osaka (JP)

(21) Appl. No.: 14/350,788

(22) PCT Filed: Aug. 28, 2013
(86) PCT No.: PCT/JP13/05081

§ 371 Date: Apr. 9, 2014

(30) Foreign Application Priority Data
Oct. 10, 2012 (JP) 2012-225497

(51) Int. Cl. H02J 7/00; H02J 1/00; H01M 8/04; H01M 16/00; H01M 10/06

(52) U.S. Cl. CPC H02J 7/0054; H01M 16/006; H01M 10/06; H01M 8/04932; H02J 1/00; H02J 2001/004; H02J 2007/0059

(57) ABSTRACT

A charging method including the steps of: supplying oxidant at a first flow rate AQ to a fuel cell; supplying fuel at a second flow rate FQ to the fuel cell; charging a lead-acid battery with electric power generated by the fuel cell, with an output current If of the fuel cell being kept constant; reducing a charge current Ib along with increasing a battery voltage Eb of the lead-acid battery; reducing the output current If so as to make an output voltage Ef of the fuel cell equal to or more than a lower-limit voltage value DE when the output voltage Ef drops to the lower-limit voltage value DE as the electric power generated by the fuel cell decreases; and reducing the output current If when the battery voltage Eb reaches a first upper-limit voltage ER1, (n−1) times, from a 1^{st} current If (1) to an n^{th} current If (n).

### TECHNICAL FIELD

The present invention relates to a fuel cell system, and specifically relates to charging control of a fuel cell system for charging electric power generated by a fuel cell into a lead-acid battery and supplying the power outside of the system.

### BACKGROUND ART

As the performance of mobile equipment such as cellular phones, notebook personal computers, and digital cameras improves, polymer electrolyte fuel cells utilizing polymer electrolyte membranes are expected as power sources therefor. Among polymer electrolyte fuel cells (hereinafter simply referred to as “fuel cells”), direct oxidation fuel cells, which supply liquid fuel such as methanol directly to the anode, are suitable for size and weight reduction, and are being developed as power sources of mobile equipment and portable power generators.

Fuel cells are highly effective in power generation and produce less noise and vibration than ordinary power generators, and therefore, are expected also as energy sources of medium-size power supply devices for consumer use for which quietness is required. For example, it has been examined to use fuel cells in power supply devices for outdoor activities. Because of the high efficiency of power generation, fuel cells require only a minimum amount of fuel to be carried with. Moreover, because of the small noise during power generation, they can be used in the night time in an area adjacent to residential district.

A power supply device including a fuel cell preferably includes a secondary battery in order to effectively utilize the power generated by the fuel cell. The power generation efficiency of fuel cells may decline during the period after the operation is started until it is stabilized, and even after the operation is stabilized, it is sometimes difficult to adjust the amount of power to be generated in quick response to fluctuating load.

In the case of, for example, a medium-size power supply device for outdoor activities, the secondary battery included in the fuel cell system is preferably a lead-acid battery. For such power supply devices, the demand for miniaturization is not so strong as compared with those for portable electronic equipment such as cellular phones. Therefore, there is little need to use, for example, a lithium ion secondary battery with high capacity and high energy density, and a lead-acid battery can be effectively used to reduce the cost.

Lead-acid batteries do not suffer from memory effect, but when deep-discharged, they are acceleratedly deteriorated. If used in such a way, they may become inoperable after several times of use. Therefore, in order to avoid being overdischarged, lead-acid batteries are desirably charged immediately after use, so that they are always at full capacity.

Regarding to the above, in the conventional system to charge a lead-acid battery by a fuel cell, there has been proposed to employ a constant-current and constant-voltage charging method to charge the lead-acid battery, as disclosed in Patent Literatures 1 and 2.

### CITATION LIST

### Patent Literature

### [PTL 1] Japanese Laid-Open Patent Publication No. 2006-5979

### [PTL 2] Japanese Laid-Open Patent Publication No. 2006-236610

### SUMMARY OF INVENTION

### Technical Problem

However, in the case of charging a lead-acid battery using a fuel cell as the energy source, it is sometimes difficult to charge the lead-acid battery to the full by the conventional constant-current and constant-voltage charging method. In constant-current charging, the battery voltage (charge voltage) rises as the charging proceeds. Therefore, in constant-current charging, the load of the fuel cell increases gradually as the charging proceeds. When the load of the fuel cell exceeds the rated output, the power generation efficiency will decline sharply. In order to avoid this to happen, it is necessary to use a fuel cell with a higher rated output. This, as a result, increases the cost of the power supply device.

In order to avoid the above inconvenience, in constant-current and constant-voltage charging, it is necessary to stop the constant-current charging at an earlier timing and switch it to the constant-voltage charging. However, the higher the ratio of the amount of electricity obtained by the constant-voltage charging relative to the amount of electricity required for full charging is, the longer the charging time is. For the reason as above, when the cost of the power supply device including a fuel cell is reduced, it will take a longer time to charge the lead-acid battery to the full. Thus the lead-acid battery fails to be always at full charge. As a result, it becomes difficult to sufficiently improve the cycle life of the lead-acid battery. Moreover, in the constant-voltage charging, the quantity of electricity needed for charging is very small. Therefore, when the constant-voltage charging is performed using the power generated by the fuel cell, the power generation efficiency of the fuel cell may decline.

Furthermore, the power generated by the fuel cell may drop after a certain period of time has passed since the power generation was started and stabilized (see FIG. 5). The causes therefor is not necessarily clear, but one possible explanation is that water produced during power generation accumulates in the fuel flow path for supplying fuel or the oxidant flow path for supplying oxidant to the fuel cell, increasing the flow path resistance. It is therefore desirable to stop the power generation at the time when a certain period of time has passed since the start of power generation, to execute a reset operation such as one for eliminating the water accumulation in the oxidant flow path.

On the other hand, as mentioned above, the power generation efficiency of the fuel cell may decline during the period after the power generation is started until it is stabilized. Therefore, in view of preventing a decline in the power generation efficiency due to repetitive start and stop of the operation of the fuel cell, it is desirable, for example, to operate the fuel cell continuously without stopping it, once the operation of the fuel cell is started for charging the lead-acid battery, until the charging of the lead-acid battery is completed.

### Solution to Problem

One aspect of the present invention relates to a charging method for a fuel cell system including a fuel cell and a lead-acid battery, to charge the lead-acid battery with electric power generated by the fuel cell. The method includes the steps of:

(i) supplying oxidant at a first flow rate AQ to the fuel cell;

(ii) supplying fuel at a second flow rate FQ to the fuel cell;

(iii) charging the lead-acid battery with electric power generated by the fuel cell with an output current If of the fuel cell being kept constant;

(iv) adjusting a charge current Ib of the lead-acid battery in accordance with a battery voltage Eb of the lead-acid battery;

(v) adjusting the output current If so as to make an output voltage Ef of the fuel cell equal to or more than a lower-limit voltage value DE, when the output voltage Ef drops to the lower-limit voltage value DE as the electric power generated by the fuel cell decreases; and
(vi) reducing the output current If when the battery voltage Eb reaches a first upper-limit voltage ER1, (n−1) times, from a 1^{st} current If(1) to an n^{th} current If(n), where n is an integer of 2 or more and If(1)>If(2)> . . . .

Another aspect of the present invention relates to a fuel cell system including:

a fuel cell;

a first current sensor for detecting an output current If of the fuel cell;

a first voltage sensor for detecting an output voltage Ef of the fuel cell;

a lead-acid battery to be charged with electric power generated by the fuel cell;

a DC/DC converter connected to an output terminal of the fuel cell, and configured to transform the output voltage Ef so as to set the output current If, and to output the electric power generated by the fuel cell to the lead-acid battery;

a second voltage sensor for detecting a battery voltage Eb of the lead-acid battery; and

a charge control unit configured to set a voltage transformation ratio PS of the DC/DC converter so as to adjust the output current If, and so as to adjust a charge current Ib of the lead-acid battery in accordance with the battery voltage Eb.

The charge control unit sets the voltage transformation ratio PS so as to make the output voltage Ef equal to or more than a lower-limit voltage value DE, when the output voltage Ef drops to the lower-limit voltage value DE as the electric power generated by the fuel cell decreases during charging of the lead-acid battery with electric power generated by the fuel cell with the output current If being kept constant.

The charge control unit also sets the voltage transformation ratio PS so as to reduce the output current If when the battery voltage Eb reaches a first upper-limit voltage ER1, (n−1) times, from a 1^{st} current If(1) to an n^{th} current If(n), where n is an integer of 2 or more and If(1)>If(2)> . . . .

### Advantageous Effects of Invention

According to the present invention, it is possible to realize at least one of: shortening a charging time without increasing the cost of the fuel cell system, giving a longer life of the lead-acid battery used in the fuel cell system, and improving power generation efficiency of the fuel cell.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A schematic block diagram of a fuel cell system according to one embodiment of the present invention

FIG. 2 A schematic cross-sectional view of a cell of a fuel cell used in the fuel cell system of FIG. 1

FIG. 3 A graphic representation of the outline of charging process performed by the fuel cell system of FIG. 1

FIG. 4 A graphic representation of the output characteristics of the fuel cell used in the fuel cell system of FIG. 1

FIG. 5 A graph showing the changes over time of the maximum power generated by the fuel cell of FIG. 1

FIG. 6 A flowchart of the charging process in the fuel cell system of FIG. 1

### DESCRIPTION OF EMBODIMENTS

The present invention relates to a charging method for a fuel cell system including a fuel cell and a lead-acid battery, in which the lead-acid battery is charged with electric power generated by the fuel cell. The method includes the steps of: (i) supplying oxidant at a first flow rate AQ to the fuel cell; (ii) supplying fuel at a second flow rate FQ to the fuel cell; (iii) charging the lead-acid battery with electric power generated by the fuel cell with an output current If of the fuel cell being kept constant; and (iv) adjusting a charge current Ib of the lead-acid battery in accordance with a battery voltage Eb of the lead-acid battery. Here, the first flow rate AQ and the second flow rate FQ can be set higher than, for example, those corresponding to the rated output of the fuel cell, by a predetermined amount.

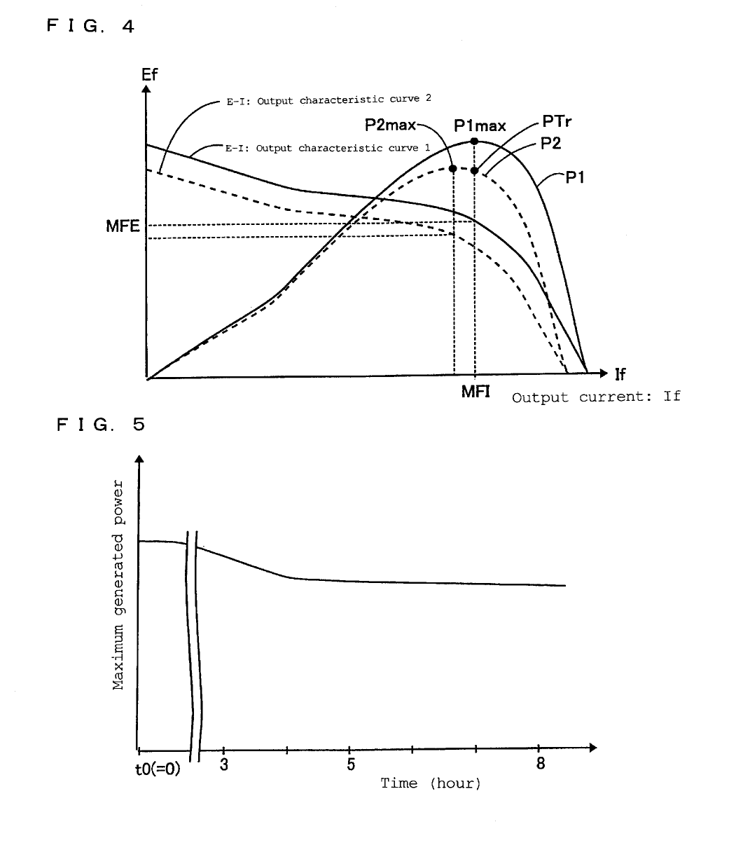

By keeping constant the output current If of the fuel cell, the operation of the fuel cell can be stabilized, and the power generation efficiency can be improved. In other words, it becomes easy to always operate the fuel cell at the point where the output power reaches a maximum or near maximum, relative to the actual fuel consumption. As shown in FIG. 4, the output current If and output voltage Ef of the fuel cell at which an output power P1 reaches a maximum (P1ₘₐₓ) are specified. Therefore, by keeping the output current If constant at such a current value (e.g., MFI in FIG. 4), it becomes easy to always operate the fuel cell at the point where the efficiency of power generation is maximized. Here, the graph of the output power P1 and the output characteristic curve 1 corresponding thereto shown in FIG. 4 represent where the fuel cell is operated at the rated output.

The present invention further includes the step of (v) adjusting the output current If so as to make the output voltage Ef of the fuel cell equal to or more than a lower-limit voltage value DE, when the output voltage Ef drops to the lower-limit voltage value DE as the power generated by the fuel cell decreases. As mentioned above, after a certain period of time has passed since the start of power generation, the power generated by the fuel cell drops because of, for example, water accumulation in the oxidant flow path (see FIG. 5). At this time, the fuel consumption also decreases. As a result, the output characteristics of the fuel cell change, for example, as shown in FIG. 4, from the graphs of the output characteristic curve 1 and the output power P1 to graphs of an output characteristic curve 2 and an output power P2 represented by the broken lines. Accordingly, the point where the power generation efficiency is maximized (hereinafter referred to as the “efficiency maximum point”) is displaced from P1ₘₐₓ to P2ₘₐₓ.

As a result, the output voltage Ef will drop as the generated power decreases, if the output current If of the fuel cell is kept constant at the initial value while charging the lead-acid battery. This is accompanied by a decline in the efficiency of power generation. Therefore, when the output voltage Ef drops to a certain level, the output current If had better be reduced accordingly, so that the efficiency of power generation is kept high. In other words, there is a turning point after which the power generation efficiency improvement effect achieved by keeping the output current If constant is surpassed by that achieved by adjusting the output current If so as to follow the displacement of the efficiency maximum point. The lower-limit voltage value DE is preferably set on the basis of the turning point.

More specifically, the lower-limit voltage value DE is preferably set such that the difference between the lower-limit voltage value DE and an optimum output voltage MFE during rated output operation will not exceed a specific value of 0.01 to 0.1 V/cell. When the output voltage Ef drops below the specific value, if the output current If is kept unchanged at, for example, the optimum output current MFI, the power generation efficiency declines significantly. In the case of the output characteristic curve 2, the power generation efficiency declines by an amount corresponding to (P2ₘₐₓ−PTr). Therefore, setting the lower-limit voltage value DE of the output voltage Ef to a specific value whose difference from the optimum output voltage MFE is from 0.01 to 0.1 V/cell, and preferably, from 0.05 to 0.1 V/cell is effective for preventing a decline in power generation efficiency. Here, “one cell” refers to a fuel cell including only one membrane electrode assembly (MEA). A fuel cell system usually includes a cell stack formed by stacking a plurality of cells with a separator interposed therebetween.

The present invention further includes the step of (vi) reducing the output current If when the battery voltage Eb of the lead-acid battery reaches a first upper-limit voltage ER1, so as to make the battery voltage Eb equal to or less than the first upper-limit voltage ER1. As shown in FIG. 3, the output current If of the fuel cell is reduced when the battery voltage Eb reaches the first upper-limit voltage ER1, i.e., reduced stepwise, (n−1) times, from a 1^{st} current If(1) to an n^{th} current If(n), where n is an integer of 2 or more and If(1)>If(2)> . . . . The 1^{st} current If(1) corresponds to the output current If at the time when the battery voltage Eb reaches the first upper-limit voltage ER1 for the first time. Therefore, the 1^{st} current If(1) tends to be smaller than an initial value Ifa of the output current If because of the reason said above.

At this time, the output voltage Ef is increased stepwise, (n−1) times, from a 1^{st} voltage Ef(1) to an n^{th} voltage Ef(n), so as to maximize or nearly maximize the power generation efficiency. It is to be noted that when the output current If is reduced stepwise, the power generated by the fuel cell and the amount of fuel consumed also decrease stepwise. As a result, the charge current Ib also decreases stepwise. When the charge current Ib decreases stepwise, as shown in FIG. 3, in synchronization with the timing thereof, the battery voltage (charge voltage) Eb drops and then rises again repetitively.

As described above, by reducing the output current If of the fuel cell when the battery voltage Eb rises up to the first upper-limit voltage ER1, it is possible to prevent the fuel cell from operating beyond the rated output. This can prevent a decline in the power generation efficiency of the fuel cell. Therefore, the efficiency of the system as a whole can be improved. Furthermore, by reducing the output current If stepwise, the lead-acid battery can be charged immediately before fully charged or until fully charged, at sufficiently high power generation efficiency of the fuel cell, even though the power generated by the fuel cell drops due to the aforementioned water accumulation etc. Thus the constant-voltage charging that needs to gradually reduce the power generated by the fuel cell to a very small value can be omitted. In that way, the lead-acid battery can be charged at a comparatively high rate (the quantity of electricity charged per unit time) until it is fully charged. Moreover, a decline in the power generation efficiency of the fuel cell due to too much decrease in the generated power can be prevented. Therefore, the power generation efficiency can be further improved, and the charging time can be further shortened.

In a preferred embodiment of the present invention, the first flow rate AQ and the second flow rate FQ are reduced, along with reducing the output current If from the 1^{st} current If(1) to the n^{th} current If(n). In the case of reducing the output current If stepwise from the 1^{st} current If(1) to the n^{th} current If(n), the first and second flow rates AQ and FQ can be reduced stepwise accordingly. When the output current If is reduced, and the output voltage Ef is increased accordingly (see FIG. 3), the power generated by the fuel cell decreases. Consequently, the amount of fuel and oxidant consumed for power generation also decreases. Therefore, it is possible to reduce the amount of fuel and oxidant to be supplied. Reducing the amount of fuel and oxidant to be supplied can reduce the power consumption of the auxiliary units such as a fuel pump and an oxidant pump (air pump). As a result, the efficiency of the system as a whole can be improved. It is to be noted that the concentration of the fuel supplied to the fuel cell (the concentration of the aqueous fuel solution) may be reduced along with reducing the output current If. This can suppress the fuel crossover and improve the power generation efficiency.

In a further preferred embodiment of the present invention, when the output current If is reduced to the n^{th} current If(n), the lead-acid battery is charged until the battery voltage Eb reaches a second upper-limit voltage ERₘₐₓ, where ERₘₐₓ>ER1, with the output current If being kept constant at the n^{th} current If(n). Thereby, the power generated by the fuel cell is kept almost constant, and the lead-acid battery can be charged with the generated power, at an almost constant current Ib (see FIG. 3). Therefore, the lead-acid battery can be charged at a comparatively large current until it is fully or nearly fully charged, and full charge can be achieved in a short period of time as compared with, for example, when charged by constant-voltage charging.

As a result, it becomes easy to always keep the lead-acid battery at full charge or nearly full charge. Therefore, the life of the lead-acid battery can be prolonged. Here, in a lead-acid battery (e.g., nominal voltage: 12 V), the first upper-limit voltage ER1 is set to 14.4±0.1 V, and the second upper-limit voltage ERₘₐₓ is set to 14.5 V to 18.0 V, where ERₘₐₓ>ER1. Even before the battery voltage Eb reaches the second upper-limit voltage ERₘₐₓ, the charging may be ended upon completion of charging at the n^{th} current (n) for a certain period of time (e.g., for 0.25 to 5.0 hours, preferably for 1.5 to 2.5 hours).

The lead-acid battery usually includes in its container a plurality of cell chambers. The cell chambers each house an electrode group and an electrolyte. The electrode groups housed in the cell chambers are connected to each other in series and/or in parallel. Given that the nominal voltage NV is, for example, 2 V, 4 V, or 6 V, the first upper-limit voltage ER1 can be set to NV×1.2±0.1 V, and the second upper-limit voltage ERₘₐₓ can be set to a value higher than the first upper-limit voltage ER1 and equal to or less than NV×1.5 (V).

The present invention also relates to a fuel cell system including: a fuel cell; a first current sensor for detecting the output current If of the fuel cell; a first voltage sensor for detecting the output voltage Ef of the fuel cell; a lead-acid battery to be charged with electric power generated by the fuel cell; a DC/DC converter connected to an output terminal of the fuel cell, and configured to transform the output voltage Ef so as to set the output current If, and to output the electric power generated by the fuel cell to the lead-acid battery; a second current sensor for detecting the charge current Ib; a second voltage sensor for detecting the battery voltage Eb of the lead-acid battery; and a charge control unit configured to set a voltage transformation ratio PS of the DC/DC converter so as to adjust the output current If, and so as to adjust the charge current Ib of the lead-acid battery in accordance with the battery voltage Eb.

The charge control unit sets the voltage transformation ratio PS so as to keep the output current If constant during the period when the battery voltage Eb is below the first upper-limit voltage ER1. The charge control unit sets the voltage transformation ratio PS so as to reduce the output current If, to make the output voltage Ef equal to or more than the lower-limit voltage value DE, when the output voltage Ef drops to the lower-limit voltage value DE as the generated power decreases. This is for the reason that, as shown in FIG. 5, the maximum power generated by the fuel cell gradually drops after the power generation is started and the operation is stabilized (t0). By adjusting the output current If, the fuel cell can be always operated at maximum or near maximum power generation efficiency, relative to the actual fuel consumption.

In addition, the charge control unit sets the voltage transformation ratio PS so as to reduce the output current If, to make the battery voltage Eb equal to or less than the first upper-limit voltage ER1, when the battery voltage Eb reaches the first upper-limit voltage ER1. This can prevent the amount of power generated by the fuel cell from exceeding the rated output. Therefore, a decline in power generation efficiency of the fuel cell can be prevented. Here, the voltage transformation ratio PS can be set so as to reduce the output current If when the battery voltage Eb reaches the first upper-limit voltage ER1, i.e., reduce stepwise, (n−1) times, from the 1^{st} current If(1) to the n^{th} current If(n), where n is an integer of 2 or more, and If(1)>If(2)> . . . . At this time, the output voltage Ef is increased stepwise, (n−1) times, from the 1^{st} voltage Ef(1) to the n^{th} voltage Ef(n). When the output current If is reduced stepwise, the charge current Ib and the battery voltage Eb drop temporarily. As a result, the power generated by the fuel cell decreases, and the amount of fuel consumed by the fuel cell also decreases.

The initial value Ifa of the output current If at the start of charging of the lead-acid battery is preferably set on the basis of an optimum output current MFI at which the output of the fuel cell reaches a maximum when the fuel cell is operated, for example, at the rated output. The aforementioned lower-limit voltage value DE is preferably set on the basis of an optimum output voltage MFE at which the output of the fuel cell reaches a maximum when the fuel cell is operated, for example, at the rated output. As shown in FIG. 4, the portion of the graph around the point P1ₘₐₓ (MFI or MFE) at which the output power P1 of the fuel cell reaches a maximum is sufficiently gently curved. Therefore, the initial value Ifa of the output current If can be set to a value whose difference from the optimum output current MFI is within the range of 0 to 3000 mA. Likewise, the lower-limit voltage value DE can be set to a value whose difference from the optimum output voltage MFE is within the range of 0.01 to 0.1 V/cell, and preferably 0.05 to 0.1 V/cell.

The present fuel cell system may further include a fuel pump for pumping fuel to the fuel cell, and an oxidant pump for pumping oxidant to the fuel cell. The charge control unit preferably outputs an instruction to reduce the pumping rate of at least one of the fuel pump and the oxidant pump, along with reducing the output current If. Such an instruction can be sent to a pump control unit for controlling those pumps. This can reduce the power consumption of at least one of the fuel and oxidant pumps, and thus can improve the efficiency of the system as a whole. The pump control unit and the charge control unit may be configured as one control device.

The fuel cell may be one utilizing methanol as fuel, such as a direct methanol fuel cell. In this case, the oxidant may be air.

A specific embodiment of the present invention is described below with reference to drawings.

### Embodiment 1

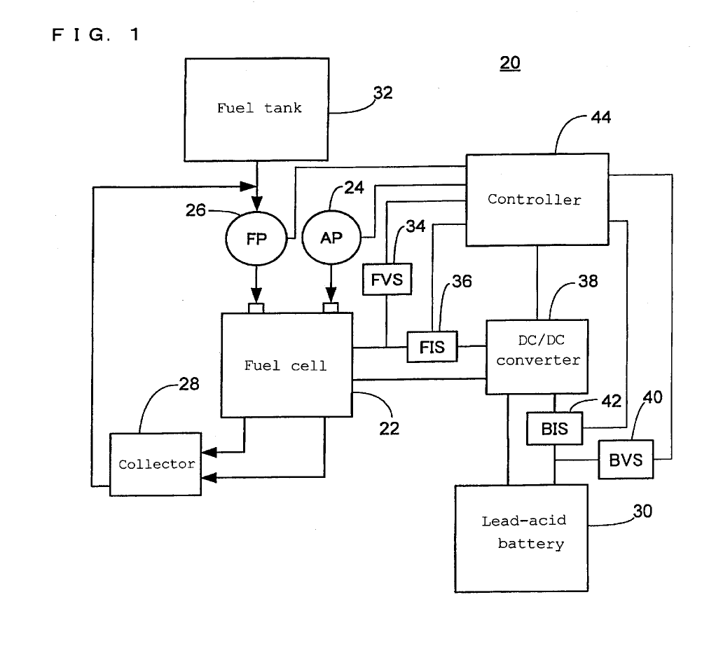

As illustrated in FIG. 1, a direct oxidation fuel cell system 20 according to the present embodiment includes a direct oxidation fuel cell (fuel cell stack) 22 including a cathode and an anode, an air pump 24 for pumping air to the cathode, a fuel pump 26 for pumping an aqueous fuel solution to the anode, a collector 28 for collecting an anode fluid discharged from the anode and a cathode fluid discharged from the cathode, a lead-acid battery 30 for storing electric power generated by the fuel cell 22, and a controller 44. The controller 44 includes a charge control unit. The lead-acid battery 30 may be a valve-regulated lead-acid battery or a so-called deep-cycle battery.

The controller 44 may be an information processor such as a microcomputer. The information processor comprises a computing unit, a memory unit, and various interfaces. The computing unit performs calculation necessary for power generation of the fuel cell, according to the program stored in the memory unit, and outputs an order (instruction) necessary for controlling the output of each component element of the fuel cell system. The memory unit (an auxiliary memory such as a flash memory) of the controller 44 can store the 1^{st} current If(1) to the n^{th} current If(n), the 1^{st} voltage Ef(1) to the n^{th} voltage Ef(n), a 1^{st} oxidant supply rate AQ(1) to an n^{th} oxidant supply rate AQ(n), a 1^{st} fuel supply rate FQ(1) to an n^{th} fuel supply rate FQ(n), and the lower-limit voltage value DE, as described hereinafter. The computing unit (including a main memory) of the controller 44 can read the above data from the memory unit, as needed, for executing the charging process of the present embodiment.

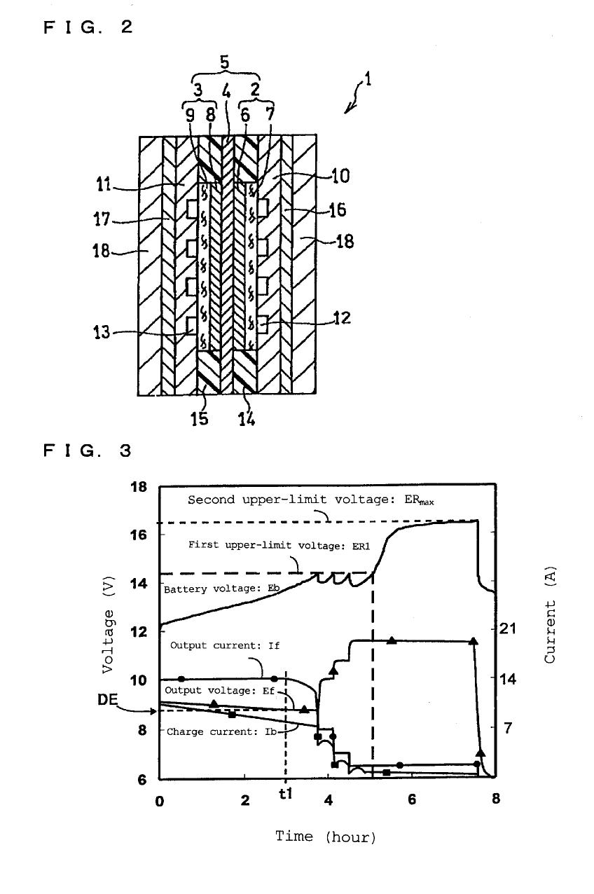

FIG. 2 illustrates the structure of a cell included in the fuel cell (fuel cell stack) 22. A cell 1 has a membrane electrode assembly (MEA) 5 including an anode 2, a cathode 3, and an electrolyte membrane 4 interposed between the anode 2 and the cathode 3. On one side of the MEA 5, a gasket 14 is disposed so as to seal the anode 2. On the other side of the MEA 5, a gasket 15 is disposed so as to seal the cathode 3.

The MEA 5 is sandwiched between an anode-side separator 10 and a cathode-side separator 11. The anode-side separator 10 is in contact with the anode 2, and the cathode-side separator 11 is in contact with the cathode 3. The anode-side separator 10 has a fuel flow path 12 for supplying fuel to the anode 2. The fuel flow path 12 has an anode inlet through which fuel enters, and an anode outlet through which CO₂ produced by the reaction and unused fuel are discharged. The cathode-side separator 11 has an oxidant flow path 13 for supplying oxidant to the cathode 3. The oxidant flow path 13 has a cathode inlet through which oxidant enters, and a cathode outlet through which water produced by the reaction and unused oxidant are discharged.

A plurality of the cells as illustrated in FIG. 2 are prepared and stacked electrically in series, thereby to form a stack. In this case, the anode-side separator 10 and the cathode-side separator 11 are usually formed as one separator. Specifically, one side of one separator serves as an anode-side separator, and the other side thereof serves as a cathode-side separator. The anode inlets of the cells are usually converged into one by, for example, using a manifold. Likewise, the anode outlets, cathode inlets, and cathode outlets are respectively converged into one.

The anode-side space in the fuel cell system, i.e., the space extending from the fuel pump 26 through the anode to the liquid in the collector, is hermetically closed, so that oxygen cannot enter the anode 2 while the operation of the fuel cell is being stopped. The anode 2 of the MEA 5 is sealed with the gasket 14 so as to allow only the anode inlets and outlets to communicate with the exterior. Conductor plates 16 and 17 are disposed in contact with the anode-side and cathode-side separators 10 and 11, respectively, and in that way, the cells 1 can be stacked so as to be electrically connected in series. End plates 18 are disposed in contact with the conductor plates 16 and 17, respectively, and in that way, the stacked cells 1 can be securely held in place.

Furthermore, in FIG. 1, air is supplied to the cathode 3 of the fuel cell via the air pump 24, while fuel (methanol) is supplied to the anode 2 of the fuel cell via the fuel pump 26. Liquid discharged on the anode side is collected into the collector 28. The liquid in the collector 28 is mixed with fuel and supplied as an aqueous fuel solution to the anode 2. Cathode fluid from the cathode 3 at least partially enters the collector 28. A high-concentration methanol from a fuel tank 32 is mixed with the liquid (thin aqueous methanol solution) from the collector 28, and pumped into the anode 2 of each cell of the fuel cell 22 by the fuel pump 26.

The fuel cell system 20 of FIG. 1 further includes: a first voltage sensor (FVS) 34 for detecting the output voltage Ef of the fuel cell 22; a first current sensor (FIS) 36 for detecting the output current If of the fuel cell 22; a DC/DC converter 38 for transforming the output voltage Ef at a voltage transformation ratio PS and outputting the electric power generated by the fuel cell to the lead-acid battery 30; a second voltage sensor (BVS) 40 for detecting the battery voltage Eb of the lead-acid battery 30 (charge voltage, the output voltage of the DC/DC converter); and a second current sensor (BIS) 42 for detecting the charge current Ib of the lead-acid battery 30 (the output current of the DC/DC converter). The detection result signals from the first voltage sensor 34, the first current sensor 36, the second voltage sensor 40, and the second current sensor 42 are input into the controller 44. The controller 44, on the basis of each detection result signal input thereinto, controls the air pump 24, the fuel pump 26, and the voltage transformation ratio PS of the DC/DC converter 38.

Next, component elements of the fuel cell used for the direct oxidation fuel cell system are described with reference to FIG. 2. It is to be noted, however, that the configuration of the fuel cell is not limited to the below.

The cathode 3 includes a cathode catalyst layer 8 contacting the electrolyte membrane 4, and a cathode diffusion layer 9 contacting the cathode-side separator 11. The cathode diffusion layer 9 includes, for example, a conductive water-repellent layer contacting the cathode catalyst layer 8, and a substrate layer contacting the cathode-side separator 11.

The cathode catalyst layer 8 includes a cathode catalyst and a polymer electrolyte. The cathode catalyst is preferably a noble metal with high catalytic activity such as Pt. The cathode catalyst may be used with or without a support. The support is preferably a carbon material such as carbon black, because of its high electronic conductivity and resistance to acids. The polymer electrolyte is preferably a proton conductive material, such as a perfluorosulfonic acid polymer material or a hydrocarbon polymer material. Examples of the perfluorosulfonic acid polymer material include Nafion (registered trademark).

The anode 2 includes an anode catalyst layer 6 contacting the electrolyte membrane 4, and an anode diffusion layer 7 contacting the anode-side separator 10. The anode diffusion layer 7 includes, for example, a conductive water-repellent layer contacting the anode catalyst layer 6, and a substrate layer contacting the anode-side separator 10.

The anode catalyst layer 6 includes an anode catalyst and a polymer electrolyte. The anode catalyst is preferably a Pt—Ru alloy catalyst, in view of reducing catalyst poisoning by carbon monoxide. The anode catalyst may be used with or without a support. The support may be a carbon material similar to that used for the cathode catalyst. The polymer electrolyte included in the anode catalyst layer 6 may be a material similar to that used for the cathode catalyst layer 8.

The conductive water-repellent layers included in the anode and cathode diffusion layers 7 and 9 each include a conducting agent and a water repellent agent. The conducting agent included in the conductive water-repellent layer may be, without limitation, any material commonly used in the field of fuel cells, such as carbon black. The water repellent agent included in the conductive water-repellent layer may be, without limitation, any material commonly used in the field of fuel cells, such as polytetrafluoroethylene (PTFE).

The substrate layer is made of an electrically conductive porous material. The conductive porous material may be, without limitation, any material commonly used in the field of fuel cells, such as carbon paper. The porous material may contain a water repellent agent in order to improve the diffusion of fuel and removal of product water. The water repellent agent may be a material similar to that included in the conductive water-repellent layer.

The electrolyte membrane 4 may be, without limitation, any conventionally-used proton conductive polymer membrane. Preferable examples thereof include a perfluorosulfonic acid polymer membrane and a hydrocarbon polymer membrane. Examples of the perfluorosulfonic acid polymer membrane include Nafion (registered trademark).

The direct oxidation fuel cell of FIG. 2 can be produced, for example, by the following method. The anode 2 is bonded onto one surface of the electrolyte membrane 4, and the cathode 3 is bonded onto the other surface thereof by, for example, hot pressing, to form an MEA 5. The MEA 5 is then sandwiched between the anode-side separator 10 and the cathode-side separator 11. At this time, the gaskets 14 and 15 are fitted to the MEA 5 so as to seal the anode 2 and the cathode 3, respectively. Thereafter, the current collector plates 16 and 17 and the end plates 18 are stacked on the outsides of the anode-side separator 10 and the cathode-side separator 11, and they are securely held in place. Heaters for temperature control may be further stacked onto the outsides of the end plates 18.

Next, description is given of the charging method of the present embodiment. The present method includes the steps of: (i) supplying oxidant at a first flow rate AQ to the fuel cell; (ii) supplying fuel at a second flow rate FQ to the fuel cell; (iii) charging the lead-acid battery with electric power generated by the fuel cell with the output current If of the fuel cell being kept constant; (iv) adjusting the charge current Ib of the lead-acid battery in accordance with the battery voltage Eb of the lead-acid battery; (v) reducing the output current If so as to make the output voltage Ef of the fuel cell equal to or more than the lower-limit voltage value DE, when the output voltage Ef drops to the lower-limit voltage value DE as the electric power generated by the fuel cell decreases; and (vi) reducing the output current If so as to make the battery voltage Eb equal to or less than the first upper-limit voltage ER1, when the battery voltage Eb reaches the first upper-limit voltage ER1. In this process, the output current If can be reduced when the battery voltage Eb reaches the first upper-limit voltage ER1, i.e., reduced stepwise, (n−1) times, from the 1^{st} current If(1) to the n^{th} current If(n), where n is an integer of 2 or more, and If(1)>If(2)> . . . . In accordance with this, the output voltage Ef can be increased stepwise, (n−1) times, from the 1^{st} voltage Ef(1) to the n^{th} voltage Ef(n). Here, n is an integer of 2 or more, If(1)>If(2)> . . . and Ef(1)<Ef(2)< . . . .

In the charging method of the present embodiment, the oxidant supply flow rate (first flow rate) AQ and the fuel supply flow rate (second flow rate) FQ are reduced along with reducing the output current If. For example, when the output current If is reduced stepwise from the 1^{st} current If(1) to the n^{th} current If(n), the first flow rate AQ and the second flow rate FQ can be reduced stepwise accordingly. Alternatively, the concentration of the fuel (aqueous solution) supplied to the fuel cell can be reduced stepwise.

In the charging method of the present embodiment, when the output current If is reduced to the n^{th} current If(n), the lead-acid battery is charged until the battery voltage Eb reaches a second upper-limit voltage ERₘₐₓ, where ERₘₐₓ>ER1, with the output current If or power generated by the fuel cell being kept unchanged. It is to be noted that even before the battery voltage Eb reaches the second upper-limit voltage ERₘₐₓ, the power generation of the fuel cell may be stopped to end the charging, after the power generation at the n^{th} current (n) has been continued for a certain period of time (e.g., for 0.5 to 2.5 hours, preferably for 1.5 to 2.5 hours).

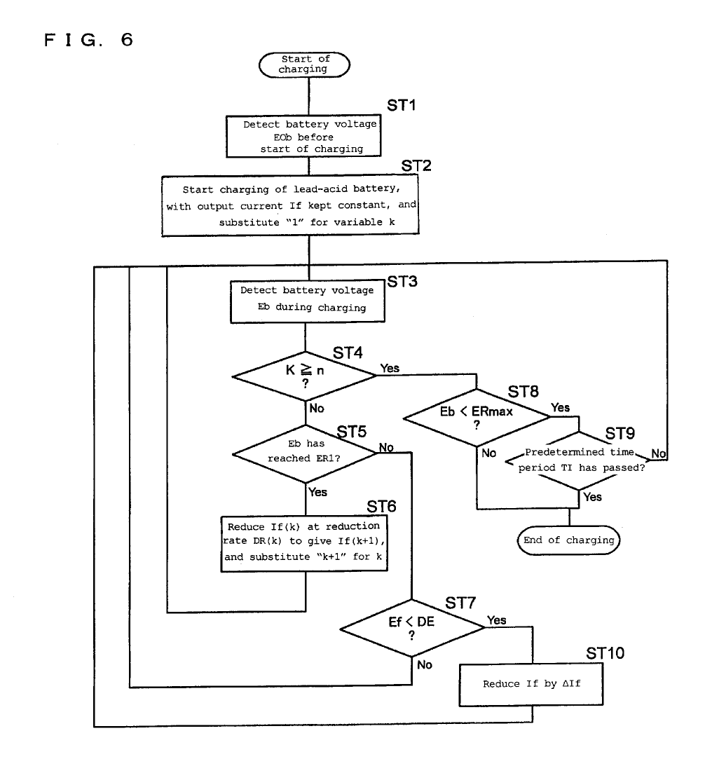

In the following, the charging method of the present embodiment is described with reference to FIGS. 4 to 6, given that the lead-acid battery 30 has a nominal voltage of 12 V, and the output current If is switched stepwise three times (n=4) at most as shown in FIG. 3.

First, a battery voltage EOb of the lead-acid battery before the start of charging is detected (ST1). Whether the charging is to be started or stopped is determined depending on the battery voltage EOb detected at ST1. If the detected voltage is equal to or less than a predetermined voltage value (e.g., 12.3 V), the output current If is set to the initial value Ifa (14 A in FIG. 3), and the charge current Ib is set to a predetermined current value (e.g. 11 A), to start the charging. The variable k associated with the number of times of switching the output current If is set to “1” (ST2). Thereby, the battery voltage Eb is increased as the charging proceeds. In advance of starting the charging, the operation of the fuel cell has been started, with the oxidant supply rate AQ(1) and the fuel supply rate FQ(1) set a little higher by a predetermined amount than those corresponding to the rated output. On the other hand, if the battery voltage EOb detected in ST1 is more than the predetermined voltage value, the lead-acid battery 30 is regarded as fully charged, and the processing is ended without performing charging.

Next, the battery voltage Eb is detected (ST3). The procedure of ST3 is executed every time period Δt (e.g., 0.1 sec), which is short enough for monitoring the battery voltage Eb. Subsequently, whether or not the variable k is equal to or more than the value “n” (n=4 in FIG. 3) is determined (ST4). If k≧n (“Yes” in ST4), the step proceeds to ST8 to determine whether or not the charging is ended. The procedures of ST8 and the subsequent steps are described hereinafter.

If the variable k is not equal to or more than the value “n” (“No” in ST4), the variable k is 1, 2, . . . , or (n−1), where (n−1)=3, and the step proceeds to ST5 to determine whether or not the battery voltage Eb has reached the first upper-limit voltage ER1. If the battery voltage Eb has reached the first upper-limit voltage ER1 (“Yes” in ST5), the output current If is reduced at, for example, a reduction rate DR(k). The variable k is then increased by the value “1” (ST6), and the step returns to ST3. In ST3, the battery voltage Eb is detected when the time period Δt has passed since the previous voltage detection (the same applies to the below). Through the procedure of ST6, the output current If is reduced from If(k) to If(k+1).

The 1^{st} current If(1) is an output current If when the battery voltage Eb reaches the first upper-limit voltage ER1 for the first time. The output current If, which is the 1^{st} current If(1), is reduced at a reduction rate DR(1), to a 2^{nd} current If(2). When the battery voltage Eb reaches the first upper-limit voltage ER1 for the second time, the output current If, which is the 2^{nd} current If(2), is reduced at a reduction rate DR(2), to a 3^{rd} current If(3). In such a way as above, the output current If is reduced from the 1^{st} current If(1) to the n^{th} current If(n). The reduction rate DR(k) can be determined in advance, or can be set as appropriate depending on the circumstances. Note that the 1^{st} current If(1) does not necessarily agree with the initial value Ifa of the output current If. Given that the output current If has been reduced through the procedures of steps ST7 and ST10 described hereinafter, the 1^{st} current If(1) is below the initial value Ifa.

Alternatively, the 2^{nd} current If(2) to the n^{th} current If(n) can be determined on the basis of the initial value Ifa. For example, the 2^{nd} current If(2) to the n^{th} current If(n) can be obtained by reducing the initial value Ifa, instead of the 1^{st} current If(1), at the reduction rate DR(k) (or a fixed reduction rate DRc) through the procedure of ST6. For example, given that n=4, the reduction rate DR(k) (or DRc) is preferably set to 40% to 50%. Alternatively, the 2^{nd} current If(2) to the 3^{rd} current If(n) can be set in advance on the basis of the optimum output current MFI. For example, given that n=4, the 2^{nd} current If(2) can be set to 50% to 70% of the MFI. The 3^{rd} current If(3) can be set to 30% to 40% of the MFI. The 4^{th} current If(4) can be set to 10% to 20% of the MFI.

As described above, since k=1 initially, the output current If switches from the 1^{st} current If(1) to the 2^{nd} current If(2) when the battery voltage Eb reaches the first upper-limit voltage ER1 for the first time. Every time when determined as “Yes” in ST5, the output current If is reduced stepwise, (n−1) times in total, from the 1^{st} current If(1) to the n^{th} current If(n). In correspondence with the switching of the output current If, the output voltage Ef is increased stepwise, (n−1) times in total, from the 1^{st} voltage Ef(1) to the n^{th} voltage Ef(n). The initial value Ifa of the output current If can be set on the basis of a current value (MFI) at which the maximum power generation efficiency can be obtained when the fuel cell 22 is operated at the rated output. For example, it can be set to a current value whose difference from the MFI is 0 to 3000 mA.

At this time, an oxidant supply rate AQ(k) and a fuel supply rate FQ(k) can be switched with switching the output current If, to an oxidant supply rate AQ(k+1) and a fuel supply rate FQ(k+1), where AQ(k+1)<AQ(k), and FQ(k+1)<FQ(k). For example, when If(k)/If(k+1)=α×(FQ(k)/FQ(k+1))=β×(AQ(k)/AQ(k+1)), α and β can be α=0.9 to 2.0, and β=0.9 to 2.0. As described above, in correspondence with the switching of the output current If, the oxidant supply rate AQ(k) can be switched, (n−1) times, from the 1^{st} oxidant supply rate AQ(1) to the n^{th} oxidant supply rate AQ(n). Likewise, the fuel supply rate FQ(1) can be switched, (n−1) times, from the 1^{st} fuel supply rate FQ(1) to the n^{th} fuel supply rate FQ(n).

In ST5, if the battery voltage Eb has not yet reached the first upper-limit voltage ER1 (“No” in ST5), whether or not the output voltage Ef of the fuel cell 22 is less than the lower-limit voltage value DE is determined (ST7). The lower-limit voltage value DE can be set on the basis of a value (MFE) at which the maximum power generation efficiency can be obtained when the fuel cell 22 is operated at the rated output. For example, it can be set to a value whose difference from the MFE is 0.01 to 0.1 V/cell.

Here, if the output voltage Ef is equal to or more than the lower-limit voltage value DE (“No” in ST7), the step returns to ST3 to continue the operation of the fuel cell with the output current If kept unchanged. On the other hand, if the output voltage Ef is less than the lower-limit voltage value DE (“Yes” in ST7), the output current If is reduced by an infinitesimal amount ΔIf so as to maximize or nearly maximize the power generation efficiency, and the step returns to ST3. In that way, the output current If is reduced. Note that, in actual use, the determination procedure of ST7 does not matter other than when k=1 (see FIG. 3). Therefore, prior to step 7, whether k=1 or not may be determined, so that the above determination procedure of ST7 is executed only when k=1.

In the above ST4, if the variable k is equal to the value “n (=4)” (“Yes” in ST4), whether or not the battery voltage Eb is less than a second upper-limit voltage ERₘₐₓ (e.g., 18.0 V) is determined (ST8). If the battery voltage Eb has reached the second upper-limit voltage ERₘₐₓ (“No” in ST8), the charging is ended immediately. If the battery voltage Eb has not yet reached the second upper-limit voltage ERₘₐₓ (“Yes” in ST8), whether or not a predetermined time period TI (e.g., 2.5 hours) has passed since the variable k was changed to the value “n (=4)” is determined (ST9). If the predetermined time period TI has passed (“Yes” in ST9), the charging is ended. If the predetermined time period TI has not passed (“No” in ST9), the step returns to ST3, and the power generation is continued at the n^{th} current If(n) (n=4) until it is determined as “No” in ST8 or “Yes” in ST9, to charge the lead-acid battery.

As described above, by charging the lead-acid battery with electric power generated by the fuel cell with the output current If of the fuel cell being kept constant, the operation of the fuel cell can be stabilized, and the power generation efficiency can be improved. Moreover, it become easy to always operate the fuel cell at the point where the output power reaches a maximum or near maximum, relative to the actual fuel consumption. Therefore, the power generation efficiency can be improved.

Furthermore, even while the fuel cell is operated at a constant output current If, the output current If is reduced so as to make the output voltage Ef equal to or more than the lower-limit voltage value DE, when the output voltage Ef drops to the lower-limit voltage value DE as the power generated by the fuel cell drops. In that way, a higher power generation efficiency can be realized, even when the power generated by the fuel cell drops with increasing operating time.

By reducing the output current If of the fuel cell when the battery voltage Eb of the lead-acid battery reaches the first upper-limit voltage ER1, it is possible to prevent the fuel cell from operating beyond the rated output. This can prevent a decline in power generation efficiency. Moreover, by reducing the output current If stepwise, for example, every time when the battery voltage Eb reaches the first upper-limit voltage ER1, (n−1) times, from the 1^{st} current If(1) to the n^{th} current If(n), the lead-acid battery can be charged at a comparatively high rate until it is fully charged or nearly fully charged, and the charging time can be shortened. As a result, the lead-acid battery can be easily held at full charge or nearly full charge all the time, and a longer life can be achieved. Moreover, by increasing the output voltage Ef stepwise along with reducing the output current If stepwise, the fuel consumption is also reduced stepwise. Therefore, the fuel cell can be always operated at maximum or near maximum power generation efficiency.

By reducing stepwise the oxidant supply flow rate AQ, and the fuel supply flow rate FQ or the concentration of fuel supplied to the fuel cell, in accordance with switching the output current If, the power consumption of the auxiliary units such as the fuel pump and the oxidant pump (air pump) can be reduced. As a result, the efficiency of the system as a whole can be improved.

Furthermore, when the output current If is reduced to the n^{th} current If(n), the lead-acid battery is charged until the battery voltage Eb reaches the second upper-limit voltage ERₘₐₓ with the output current If being kept at the n^{th} current If(n). In that way, the lead-acid battery can be charged until it is fully or nearly fully charged, with the output current If being kept constant. Therefore, a decline in the power generation efficiency of the fuel cell can be more effectively prevented.

### INDUSTRIAL APPLICABILITY

According to the present invention, the life characteristics and efficiency of a fuel cell system including a lead-acid battery can be improved. It is therefore possible to provide a fuel cell system that can maintain its excellent power generation characteristics and stable performance over a long period of time. The direct oxidation fuel cell system of the present invention is very useful as a medium-size power supply used for, for example, outdoor activities.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

20 . . . Fuel cell system,
22 . . . Fuel cell,
24 . . . Air pump,
26 . . . Fuel pump,
30 . . . Lead-acid battery,
32 . . . Fuel tank,
34 . . . First voltage sensor,
36 . . . First current sensor,
38 . . . DC converter,
40 . . . Second voltage sensor,
42 . . . Second current sensor, and
44 . . . Controller.

1. A charging method for a fuel cell system including a fuel cell and a lead-acid battery, to charge the lead-acid battery with electric power generated by the fuel cell, the method comprising steps of:
(i) supplying oxidant at a first flow rate AQ to the fuel cell;
(ii) supplying fuel at a second flow rate FQ to the fuel cell;
(iii) charging the lead-acid battery with electric power generated by the fuel cell with an output current If of the fuel cell being kept constant;
(iv) adjusting a charge current Ib of the lead-acid battery in accordance with a battery voltage Eb of the lead-acid battery;
(v) adjusting the output current If so as to make an output voltage Ef of the fuel cell equal to or more than a lower-limit voltage value DE, when the output voltage Ef drops to the lower-limit voltage value DE as the electric power generated by the fuel cell decreases; and
(vi) reducing the output current If when the battery voltage Eb reaches a first upper-limit voltage ER1, (n−1) times, from a 1^{st} current If(1) to an n^{th} current If(n), where n is an integer of 2 or more and If(1)>If(2)> . . . .

2. The charging method for a fuel cell system according to claim 1, wherein the step (vi) includes reducing the first flow rate AQ and the second flow rate FQ along with reducing the output current If from the 1^{st} current If(1) to the n^{th} current If(n).

3. The charging method for a fuel cell system according to claim 1, further comprising a step (vii) of, when the output current If is reduced to the n^{th} current If(n), charging the lead-acid battery until the battery voltage Eb reaches a second upper-limit voltage ERₘₐₓ, where ERₘₐₓ>ER1, with the output current If being kept constant at the n^{th} current If(n).

4. A fuel cell system comprising:
a fuel cell;
a first current sensor for detecting an output current If of the fuel cell;
a first voltage sensor for detecting an output voltage Ef of the fuel cell;
a lead-acid battery to be charged with electric power generated by the fuel cell;
a DC/DC converter connected to an output terminal of the fuel cell, and configured to transform the output voltage Ef so as to set the output current If, and to output the electric power generated by the fuel cell to the lead-acid battery;
a second voltage sensor for detecting a battery voltage Eb of the lead-acid battery; and
a charge control unit configured to set a voltage transformation ratio PS of the DC/DC converter so as to adjust the output current If, and so as to adjust a charge current Ib of the lead-acid battery in accordance with the battery voltage Eb, wherein
the charge control unit sets the voltage transformation ratio PS so as to make the output voltage Ef equal to or more than a lower-limit voltage value DE, when the output voltage Ef drops to the lower-limit voltage value DE as the electric power generated by the fuel cell decreases during charging of the lead-acid battery with electric power generated by the fuel cell with the output current If being kept constant; and
the charge control unit sets the voltage transformation ratio PS so as to reduce the output current If when the battery voltage Eb reaches a first upper-limit voltage ER1, (n−1) times, from a 1^{st} current If(1) to an n^{th} current If(n), where n is an integer of 2 or more and If(1)>If(2)> . . . .

5. The fuel cell system according to claim 4, wherein an initial value Ifa of the output current If at start of charging of the lead-acid battery is set on a basis of an optimum output current MFI at which output of the fuel cell reaches a maximum.

6. The fuel cell system according to claim 5, wherein a difference between the optimum output current MFI and the initial value Ifa of the output current If is 0 to 3000 mA.

7. The fuel cell system according claim 4, wherein the lower-limit voltage value DE is set on a basis of an optimum output voltage MFE at which output of the fuel cell reaches a maximum.

8. The fuel cell system according to claim 7, wherein a difference between the optimum output voltage MFE and the lower-limit voltage value DE is 0.01 to 0.1 V/cell.

9. The fuel cell system according to claim 4, further comprising:
a fuel pump for pumping fuel to the fuel cell; and
an oxidant pump for pumping oxidant to the fuel cell, wherein
the charge control unit outputs an instruction to reduce a pumping rate of at least one of the fuel pump and the oxidant pump, when the voltage transformation ratio PS is set so as to reduce the output current If.

10. The fuel cell system according to claim 4, wherein the fuel includes methanol.

11. The fuel cell system according to claim 4, wherein the oxidant includes air.
